(19) United States
(12) Patent Application Publication
(10) Pub. No.: US 2016/0119253 A1
(43) Pub. Date: Apr. 28, 2016

(54) METHOD AND SYSTEM OF PERFORMING SERVICE FUNCTION CHAINING

(71) Applicant: KT Corporation, Seongnam-si (KR)

(72) Inventors: Tae Ho KANG, Daejeon (KR); Sung Su KIM, Daejeon (KR); Eun Kyoung PAIK, Daejeon (KR)

(73) Assignee: KT CORPORATION, Seongnam-si (KR)

(21) Appl. No.: 14/921,258

(22) Filed: Oct. 23, 2015

(30) Foreign Application Priority Data
Oct. 23, 2014 (KR) 10-2014-0144523
Oct. 13, 2015 (KR) 10-2015-0142665

(51) Int. Cl. H04L 12/939; H04L 12/24; H04L 12/911; H04L 29/06; H04L 12/741

(52) U.S. Cl. CPC H04L 49/552; H04L 69/22; H04L 45/745; H04L 47/746; H04L 41/0645

(57) ABSTRACT

A method and system of performing service function chaining is disclosed. The method includes: determining a service function path (SFP) for a packet transmitted to the network device; determining a service function (SF) through which the received packet passes on the SFP; and processing the received packet based on whether a function of the SF is essential or not. Accordingly, the SFs can be categorized into mandatory SFs and optional SFs based on the functions of the SFs or the setting for the SFC and the SFC can be more stably implemented based on the categorization.

### CLAIM FOR PRIORITY

This application claims priorities to Korean Patent Application No. 10-2014-0144523 filed on Oct. 23, 2014, and Korean Patent Application No. 10-2015-0142665 filed on Oct. 13, 2015 in the Korean Intellectual Property Office (KIPO), the entire contents of which are hereby incorporated by reference.

### BACKGROUND

1. Technical Field

Example embodiments of the present invention relate to software-defined networking (SDN), and more particularly, to a method and system of performing service function chaining (SFC) in an SDN environment.

2. Related Art

Interest in openness and virtualization of a network for building future-oriented networks and service infrastructures has been increased, and the discussion on software-defined networking (SDN) and network function virtualization (NFV) techniques serving as techniques for supporting the openness and virtualization have been actively conducted. Further, interest in a service chaining or service function chaining (SFC) technique (hereinafter, referred to as ‘SFC technique’) in which one network service is implemented by selectively combining and executing required network functions according to traffic is being increased.

In general, the network service is provided by a combination of network devices that implement one or more network component functions. The network component functions are provided in various layers and locations to constitute the network service such as a firewall, deep packet inspection (DPI), a dynamic host configuration protocol (DHCP) which supports home network services, network address translation (NAT), or the like.

In particular, the SFC technique has been mainly discussed in an Internet Engineering Task Force (IETF) SFC Working Group (WG) standardization group.

However, a technique for implementing a user-friendly SFC by classifying functions of a service function (SF) lacks, in particular, the processing in a case in which a failure occurs in the SF lacks, and thus there is a problem in that the traffic forwarding itself is interrupted when the failure occurs in a particular SF.

### SUMMARY

Accordingly, example embodiments of the present invention are provided to substantially obviate one or more problems due to limitations and disadvantages of the related art.

Example embodiments of the present invention provide a method of performing service function chaining (SFC) in a software-defined networking (SDN) environment.

Example embodiments of the present invention also provide a system of performing SFC in an SDN environment.

In some example embodiments, a method of performing service function chaining (SFC) by a network device, the method comprising: determining a service function path (SFP) for a packet transmitted to the network device; determining a service function (SF) through which the received packet passes on the SFP; and processing the received packet based on whether a function of the SF is essential or not.

Here, the SFP is set by a controller which controls the network device for the SFC.

Here, the processing of the received packet may include, when a failure occurs in the SF, interrupting forwarding of the received packet and notifying a controller which controls the network device of the failure as it is determined that the function of the SF in which the failure occurs is essential.

Here, the processing of the received packet may include forwarding the received packet according to a path re-calculated by the controller which receives the failure.

Here, the processing of the received packet may include, when a failure occurs in the SF, bypassing the SF in which the failure occurs as it is determined that the function of the SF in which the failure occurs is inessential.

Here, the processing of the received packet may include, when a failure occurs in the SF, forwarding the received packet to the set backup SF as it is determined that a backup SF, with which the SF in which the failure occurs is replaced, is set. Here, the processing of the received packet may include, when a failure occurs in the

SF, determining whether the function of the SF in which the failure occurs is essential or not as it is determined that a backup SF, with which the SF in which the failure occurs is replaced, is not set.

Here, the processing of the received packet may include determining whether the function of the SF is essential or not according to the SFC applied to the received packet.

In other example embodiments, a method of performing SFC by a controller, the method comprising: setting an SFP to a network device based on a topology database (DB); receiving information on an event generated in an SF located on the SFP from the network device; and controlling the network device according to whether a function of the SF in which the event is generated is essential or not and the received event information.

Here, the controlling of the network device includes: receiving information on an event corresponding to a failure which occurs in the SF, and calculating a new SFP as it is determined that the function of the SF in which the failure occurs is essential; and setting the new SFP to the network device.

Here, the calculating of the new SFP may include calculating the new SFP by considering whether a backup SF, with which the SF in which the failure occurs is replaced, is set or not.

Here, the controlling of the network device may include receiving information on an event corresponding to a failure which occurs in the SF and controlling to bypass the SF in which the failure occurs as it is determined that the function of the SF in which the failure occurs is inessential.

In still other example embodiments, a system of performing SFC, comprising: a controller configured to determine an SFP based on a topology DB; and a network device configured to process a received packet according to the SFP determined by the controller, wherein the received packet is processed according to information on an event generated in an SF in which the received packet is processed and whether a function of the SF is essential or not.

Here, the network device forwards, when a failure occurs in the SF, the received packet to a backup SF as it is determined that the backup SF, with which the SF in which the failure occurs is replaced, is set.

Here, the network device notifies, when a failure occurs in the SF, the controller of information on the SF in which the failure occurs as it is determined that a backup SF, with which the SF in which the failure occurs is replaced, is not set and the function of the SF in which the failure occurs is essential.

Here, the controller re-calculates a new SFP, on which the received packet is processed, corresponding to the reception of the information on the SF in which the failure occurs and sets the new re-calculated SFP to the network device.

Here, the network device bypasses, when a failure occurs in the SF, the SF in which the failure occurs as it is determined that a backup SF, with which the SF in which the failure occurs is replaced, is not set and the function of the SF in which the failure occurs is inessential.

### BRIEF DESCRIPTION OF DRAWINGS

Example embodiments of the present invention will become more apparent by describing in detail example embodiments of the present invention with reference to the accompanying drawings, in which:

FIG. 1 is a diagram for describing an exemplary system of performing service function chaining (SFC) according to an embodiment of the invention;

FIG. 2 is a diagram for describing an exemplary network service header for implementing SFC according to an embodiment of the invention;

FIG. 3 is a diagram for describing an exemplary case in which a failure occurs in an SFC environment according to an embodiment of the invention;

FIG. 4 is a flowchart for describing a method of setting a service function path (SFP) by a controller according to an embodiment of the invention;

FIG. 5 is a flowchart for describing a method of performing SFC according to an embodiment of the invention focusing on a controller;

FIG. 6 is a flowchart for describing a method of performing SFC by a service function forwarder (SFF) according to an embodiment of the invention;

FIG. 7 is a flowchart for describing a method of overcoming a failure in a case in which a backup service function (SF), with which an SF in which a failure occurs is replaced, is present according to an embodiment of the invention; and

FIG. 8 is a flowchart for describing a method of overcoming a failure in a case in which a backup SF, with which an SF in which a failure occurs is replaced, is not present according to an embodiment of the invention.

### DESCRIPTION OF EXAMPLE EMBODIMENTS

specific embodiments thereof are shown by way of examples in the drawings and will herein be described in detail. It should be understood, however, that there is no intent to limit the invention to the particular forms disclosed, but on the contrary, the invention is meant to cover all modifications, equivalents, and alternatives falling within the spirit and scope of the invention. Like numbers refer to like elements in the accompanying drawings.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, it will be understood that when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a controller used in the inventive concept may be a unified software-defined networking (SDN) controller, and mean a function entity controlling relevant components (for example, a switch, a router, etc.) for controlling a flow of traffic.

Further, the controller may not be limited by physical implementation shape or position, etc. For example, the controller may mean a controller function entity defined in open networking foundation (ONF), Internet engineering task force (IETF), a European telecommunication standards institute (ETSI), and/or international telecommunication union-telecommunication (ITU-T), etc.

A network device used in the inventive concept may mean a function entity of actually forwarding, switching, or routing traffic (or a packet) such as a switch or a router. Accordingly, the network device in the inventive concept may be referred to as the switch or the router.

For example, the network device may mean the switch, the router, a switching element, a routing element, a forwarding element, SFF(Service Function Forwarder) etc. defined in the ONF, IETF, ETSI, and/or ITU-T, etc.

Hereinafter, exemplary embodiments of the invention will be described in detail with reference to the accompanying drawings.

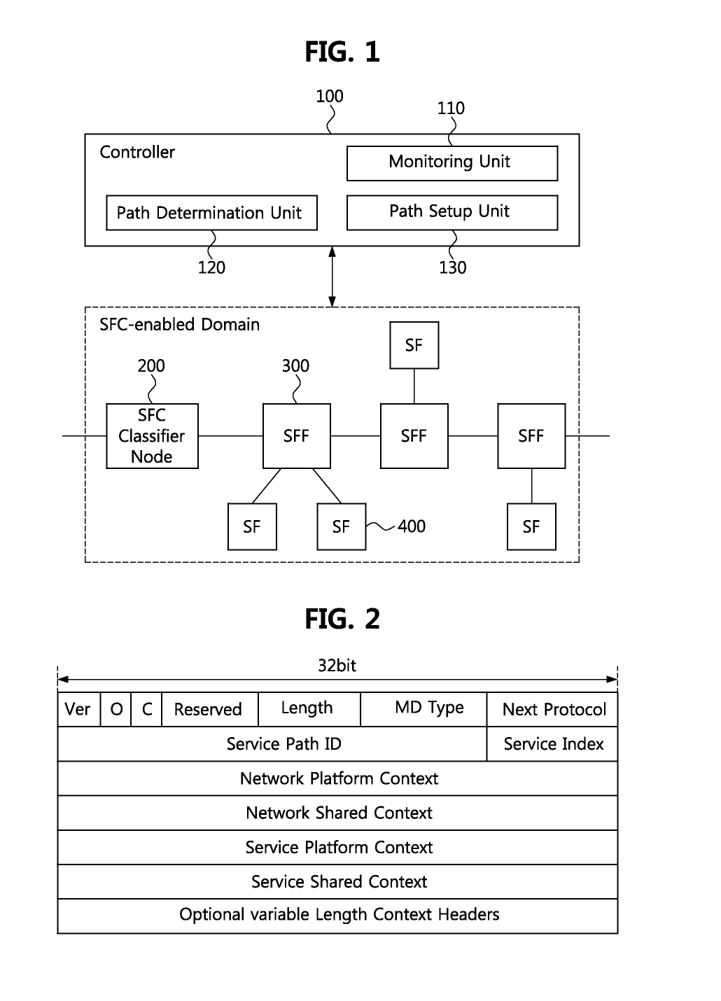

FIG. 1 is a diagram for describing an exemplary system of performing service function chaining (SFC) according to an embodiment of the invention. FIG. 2 is a diagram for describing an exemplary network service header (NSH) for implementing SFC according to the embodiment of the invention.

The SFC may be a concept in which traffic of a network user selectively passes through only functions required for the user among network services such as network address translation (NAT), firewall, intrusion prevention system (IPS), and the like, and the services may operate on a physical server or on a virtual machine. Therefore, the SFC may be understood as a concept closely related to network function virtualization (NFV).

The concept for implementing the SFC will be described as follows.

A service function (SF) may be understood as a functional block which processes a received packet, and may operate on a protocol stack having various layers. The SF, which is a logical component, may refer to a virtual element embedded in a physical network component. Alternatively, a plurality of SFs may be embedded in one network component. For example, the SF may refer to a conceptual element which performs firewall, IPS, deep packet inspection (DPI), and NAT functions. Further, duplicated SF instances may be present within the same SFC domain.

A service function forwarder (SFF) performs a function which forwards the received packet to the SF. That is, the SFF may forward traffic or a packet to at least one SF according to information forwarded from SFC encapsulation. Further, the SFF may perform a function which forwards the packet to another SFF.

A service function path (SFP) may refer to a physical network path through which the packet passes to implement the SFC of an abstract concept. A plurality of SFFs and the plurality of SFs may be present on the SFP.

The SFC encapsulation provides minimal SFP identification (ID). Further, the SFC encapsulation may be used in SFC-aware functions such as SFF, SFC aware SF, and the like, may not be used in the packet forwarding in a general network domain, and may forward data plane context information (metadata) in addition to the SFP ID.

A classifier may refer to a functional entity which performs classification or service classification. Here, the classification may refer to a process in which traffic is classified in customer/service units by a policy and the SFs used by the corresponding customer are classified according to a profile. That is, the classification may be performed through a forwarding policy suitable for the traffic and the identification of the user and the network profiles.

The SFC-enabled domain may refer to a network domain in which the SFC is implemented, and may be limited to a single network management domain.

Referring to FIG. 1, as a controller 100, an SFC classifier node 200 located on the SFC-enabled domain, a plurality of SFFs 300, and a plurality of SFs 400 are in conjunction with each other, the SFC may be implemented.

The controller 100 may control the SFC classifier node 200, the plurality of SFFs 300, and the plurality of SFs 400, which are located in the SFC-enabled domain. For example, the controller 100 may set the SFP to the SFC-enabled domain through the SFC classifier node 200.

Specifically, the controller 100 may include a monitoring unit 110 which monitors state information on the SFC classifier node 200, the plurality of SFFs 300, and the plurality of SFs 400, a path determination unit 120 which determines a path on which a packet is processed, such as the SFP, and a path setup unit 130 which sets the determined path to the SFC-enabled domain.

The SFC-enabled domain may process the received packet based on the SFP set by the controller 100.

Specifically, a structure in which the service classification is performed in the SFC-enabled domain is provided as follows.

When the traffic of the user enters the SFC-enabled domain, the corresponding traffic may be classified in customer/service units by a preset policy, the SFs 400 used by the corresponding customer may be identified according to the profile, and a path passing through the SF instance in the current SFC-enabled domain may be determined, in the SFC classifier node 200 which performs the service classification function.

Next, FIG. 2 illustrates an NSH for implementing the SFC. That is, the NSH may be encapsulated by adding information such as a service path ID, a service index, metadata, and the like as illustrated in FIG. 2. Here, the service path ID may refer to information for identifying the SFP, the service index may refer to information for identifying the network service, and the metadata may refer to various pieces of context information.

Therefore, since the NSH indicates the SFs 400 through which the corresponding packet passes and a sequence of the SFs 400, the SFFs 300 may pass through the SFs 400 according to the SFs 400 and the sequence thereof indicated in the NSH when the corresponding packet passes through the SFC-enabled domain.

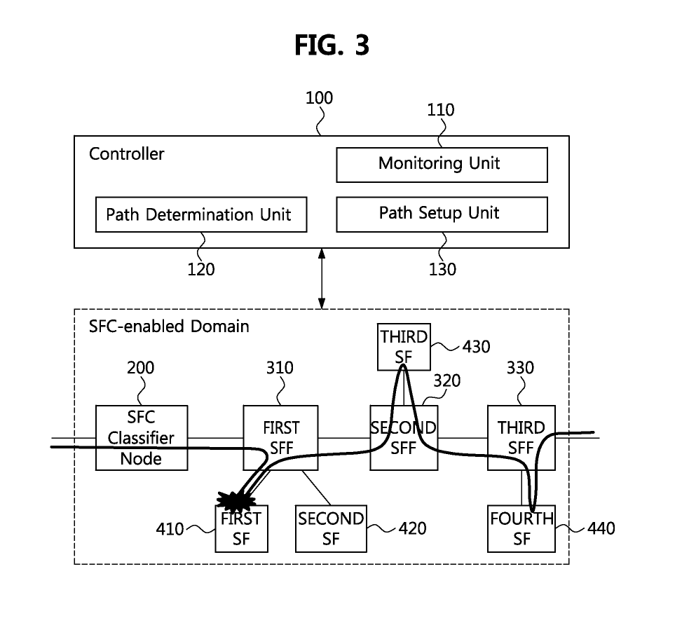

FIG. 3 is a diagram for describing an exemplary case in which a failure occurs in an SFC environment according to an embodiment of the invention.

Referring to FIG. 3, packets entering the SFC-enabled domain may be classified by the SFC classifier node 200 performing service classification.

The controller 100 may generate a service function path ID (SFPID) for identifying the SFs (e.g., NAT, Firewall, or IPS) through which the packets should actually pass to apply to the SFC-enabled domain in order to provide the services used by the corresponding customer according to the profile of the customer.

The controller 100 may add the SFPID to an SFC rule (e.g., NSH) for forwarding the packet to each of a first SFF 310, a second SFF 320, and a third SFF 330.

For example, a case in which a path is set so that the packet sequentially passes through a first SF 410, a third SF 430, and a fourth SF 440 by an SFPID ‘abcd’ will be described as follows.

The SFC classifier node 200 may forward the packet to the first SFF 310.

The first SFF 310 may forward the packet to the first SF 410, and the packet processed by the first SF 410 to the second SFF 320.

The second SFF 320 may forward the packet to the third SF 430, and the packet processed by the third SF 430 to the third SFF 330.

The third SFF 330 may forward the packet to the fourth SF 440, and the packet processed by the fourth SF 440 may be forwarded to a general network domain. Here, before the packet is forwarded to the general network domain, an SFC header may be removed.

That is, the packet forwarded to the SFC classifier node 200 may be processed through the SFP such as the first SFF 310, the first SF 410, the second SFF 320, the third SF 430, the third SFF 330, and the fourth SF 440.

In the process, a failure may occur in the first SF 410. When the failure occurs in the first SF 410, a problem in that the packet forwarding itself is interrupted may be caused. That is, even when the failure occurs in any one of the plurality of SFs 410, 420, 430, and 440 on the SFP, there is a problem in that the entire network service is interrupted.

Further, since the packet is routed based on the SFPID which is information on the SFC header and an index in the SFC-enabled domain, there is a problem in that it is difficult to use the existing L3 and L2 failure recovery technique.

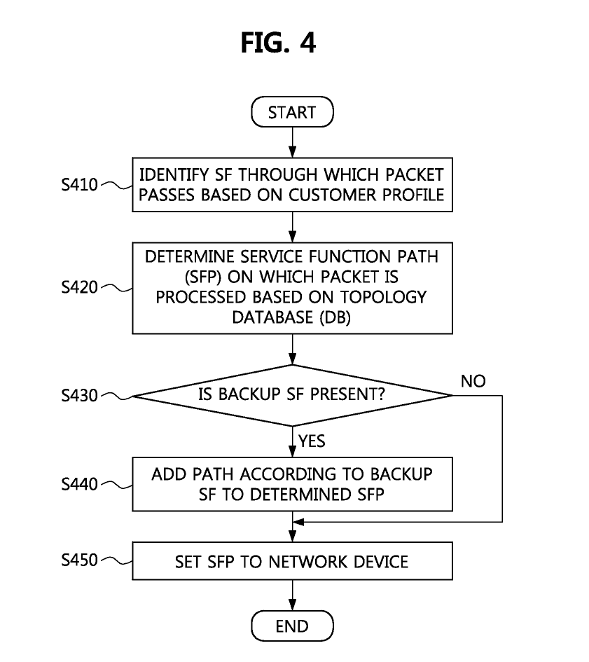

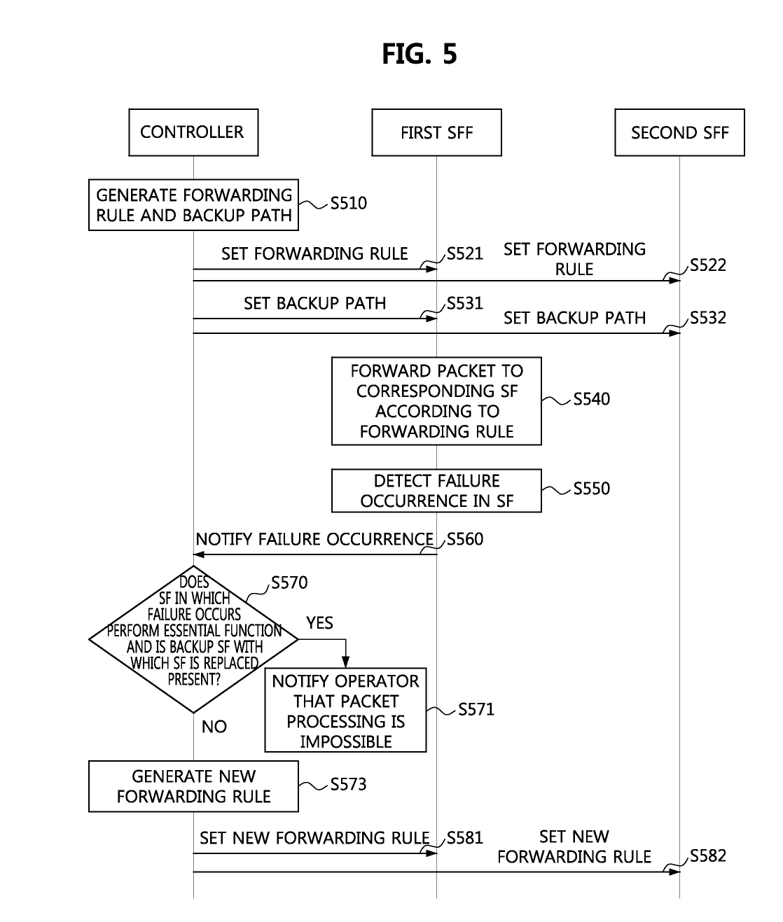

FIG. 4 is a flowchart for describing a method of setting an SFP by a controller according to an embodiment of the invention. FIG. 5 is a flowchart for describing a method of performing SFC according to an embodiment of the invention focusing on a controller.

Referring to FIG. 4, the controller may identify an SF through which a packet passes based on a customer profile (S410), and thus determine an SFP on which the packet is processed with reference to a topology DB (S420).

Further, the controller may determine whether a backup SF is present or not (S430), and add a path according to the backup SF to the determined SFP when it is determined that the backup SF is present (S440).

Therefore, the controller may set the SFP to the SFF 300 which is a network device based on the topology DB (S450).

The method of performing the SFC by the controller will be described in more detail with reference to FIG. 5.

The controller may generate a forwarding rule and a backup path based on a customer profile or the like (S510). Here, the forwarding rule may be understood as a concept corresponding to an SFP.

The controller may set the generated forwarding rule and backup path to a first SFF and a second SFF (S521, S522, S531, and S532).

The first SFF may forward the packet to the corresponding SF according to the forwarding rule set by the controller (S540). When the first SFF detects that a failure occurs in the SF to which the packet is forwarded (S550), the first SFF may notify the controller of the detection (S560). That is, the first SFF may forward information on an event generated in an SF connected to itself to the controller.

The controller may determine whether the SF in which the failure occurs can perform an essential function or not, and whether an SF, with which the SF is replaced, is present or not (S570).

Here, the SF which performs the essential function may be named a mandatory SF, and the SF which performs an optional function rather than the essential function may be named an optional SF.

For example, the mandatory SF may refer to the SF which performs the essential function for a service such as NAT or the like, and the optional SF may refer to the SF which performs the inessential function for a service such as firewall, IPS, or the like.

Furthermore, the mandatory SF and the optional SF are not divided according to a simple function of the SF, but may preset for each SFC.

When the SF in which the failure occurs performs the essential function and it is determined that the SF, with which the SF is replaced, is not present, the controller may notify an operator that the packet processing is impossible anymore (S571). Furthermore, when the SF in which the failure occurs performs the essential function and it is determined that the SF, with which the SF is replaced, is not present, the controller may notify the operator that the packet processing is impossible anymore, and at the same time generate a new forwarding rule.

Further, when the SF in which the failure occurs does not perform the essential function or it is determined that the SF, with which the SF is replaced, is present, the controller may generate the new forwarding rule (S573) and set the new forwarding rule to the first SFF and the second SFF (S581 and S582).

Therefore, referring to FIGS. 4 and 5, the controller may set the SFP to a network device based on the topology DB, receive information on the event generated in the SF located on the SFP from the network device, and control the network device according to whether the function of the SF in which the event occurs is present or not and the received event information.

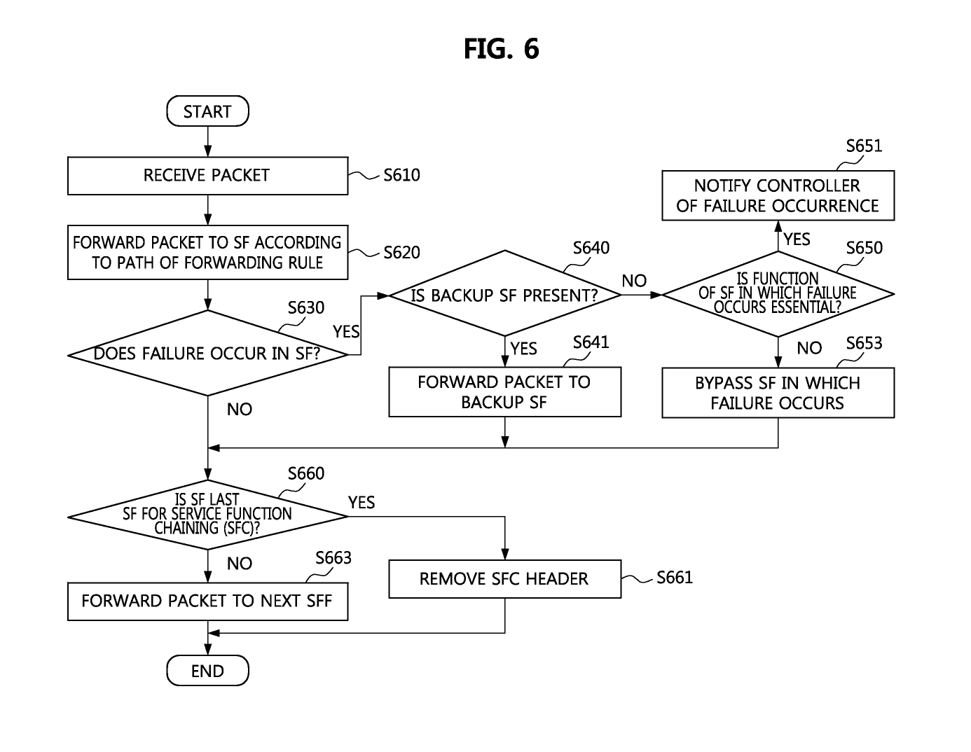

FIG. 6 is a flowchart for describing a method of performing SFC by an SFF according to an embodiment of the invention.

Referring to FIG. 6, the SFF may receive a packet (S610), and forward the received packet to an SF according to the forwarding rule (S620).

The SFF may determine whether a failure occurs or not in the SF to which the packet is forwarded (S630). When it is determined that the failure occurs in the SF, the SFF may determine whether a backup SF, with which the SF in which the failure occurs is replaced, is present or not (S640).

When it is determined that the backup SF, with which the SF in which the failure occurs is replaced, is present, the SFF may forward the packet to the backup SF (S641).

Further, when it is determined that the backup SF, with which the SF in which the failure occurs is replaced, is not present, the SFF may determine a function of the SF in which the failure occurs is essential or not (S650).

When it is determined that the function of the SF in which the failure occurs is essential, the SFF may notify the controller that the failure occurs (S651), and when it is determined that the function of the SF in which the failure occurs is inessential, the SFF may bypass the SF in which the failure occurs (S653).

The SFF may determine whether the corresponding SF is or not a last SF for the SFC (S660).

When it is determined that the corresponding SF is the last SF, the SFF may remove an SFC header according to the end of the SFC (S661).

Further, when it is determined that the corresponding SF is not the last SF, the SFF may forward the packet to a next SFF (S663).

Therefore, referring to the above description in FIG. 6, a network device may determine the SFP for the received packet, determine the SF through which the received packet passes on the SFP, and process the received packet based on whether the function of the SF is essential or not.

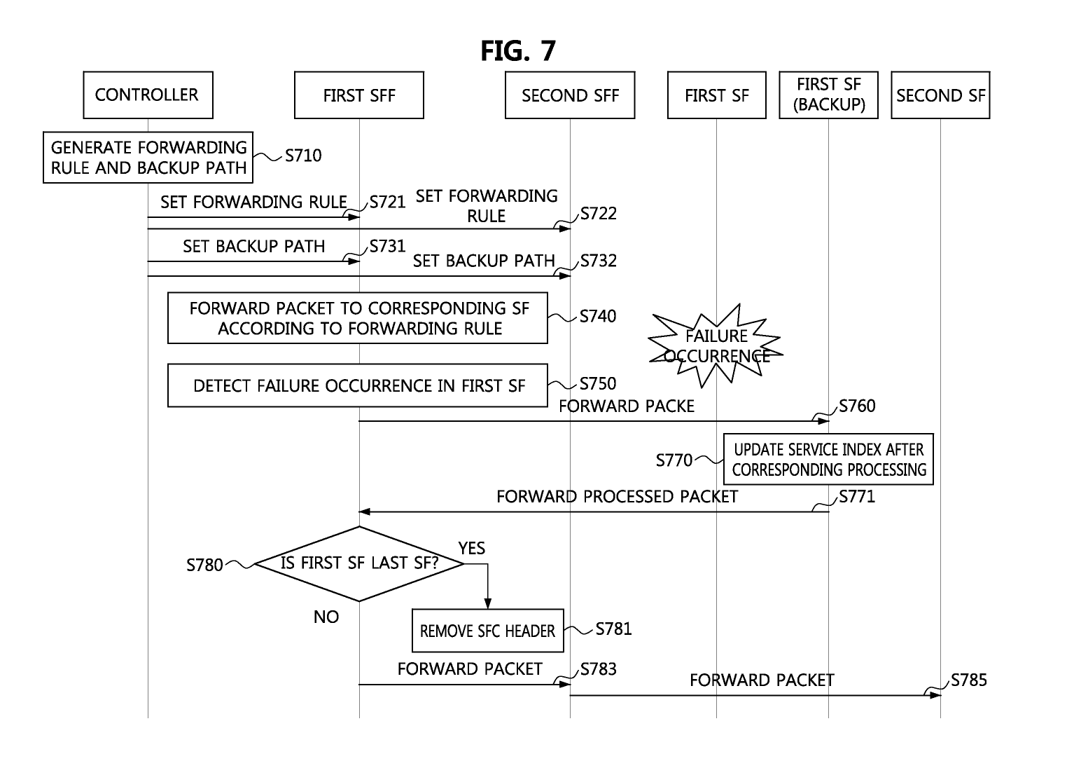

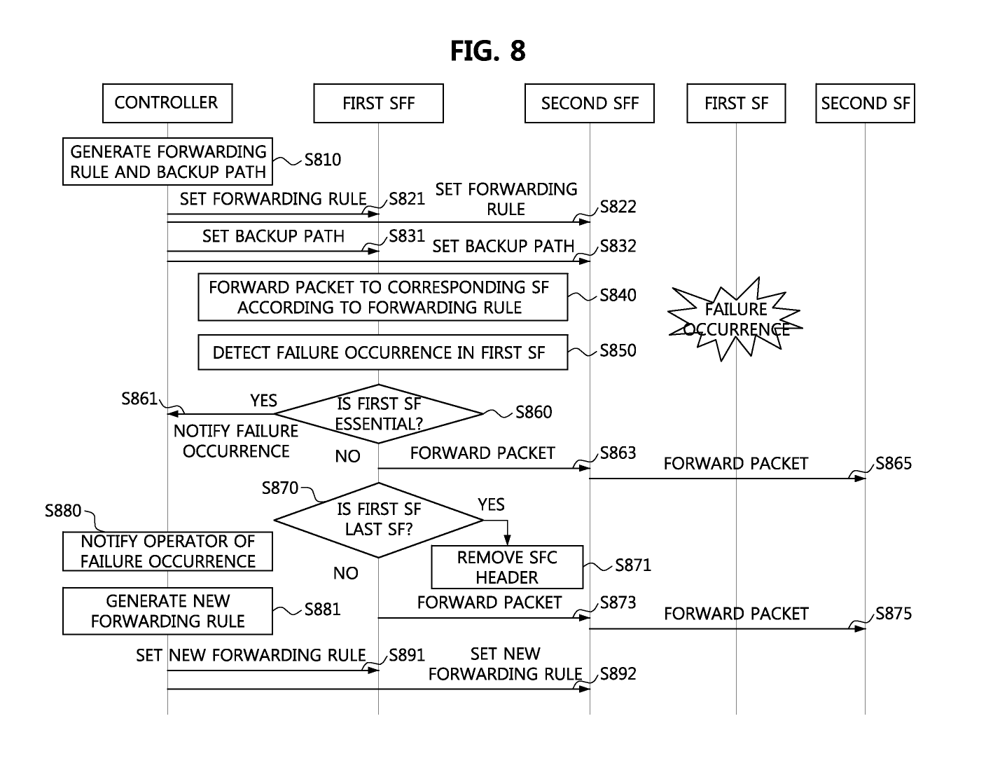

FIG. 7 is a flowchart for describing a method of overcoming a failure in a case in which a backup SF, with which an SF in which the failure occurs is replaced, is present according to an embodiment of the invention. FIG. 8 is a flowchart for describing a method of overcoming a failure in a case in which a backup SF, with which an SF in which the failure occurs is replaced, is not present according to an embodiment of the invention.

First, a method of performing SFC in a case in which a backup SF, with which an SF in which a failure occurs is replaced, is present as illustrated in FIG. 7 is provided as follows. That is, the case in which the backup SF, with which the SF in which the failure occurs is replaced, is present will be described.

A controller may generate a forwarding rule and a backup path based on a customer profile or the like (S710). Here, the forwarding rule may be understood as a concept corresponding to an SFP.

The controller may set the generated forwarding rule and backup path to a first SFF and a second SFF (S721, S722, S731, and S732).

The first SFF may forward the packet to a first SF according to the forwarding rule set by the controller (S740). When the first SFF detects that a failure occurs in the first SF to which the packet is forwarded (S750), the first SFF may forward the packet to a first SF (backup) with which the first SF is replaced (S760).

The first SF (backup) may perform a process corresponding to the first SF on the packet, and update a service index or the like included in an SFC header (S770). That is, the first SF (backup) may modify the service index of the SFC header to an index for a next SF. For example, when the service index of the first SF in which the failure currently occurs is 5 and a service index of a second SF which is the next SF is 4, the service index for the current packet may be modified to 4.

Further, the first SF (backup) may forward again the packet processed by itself to the first SFF (S771).

The first SFF may determine whether the first SF is or not a last SF for the SFC (S780).

When it is determined that the first SF is the last SF, the first SFF may remove the SFC header according to the end of the SFC (S781).

Further, when it is determined that the first SF is not the last SF, the first SFF may forward the packet to the second SFF which is the next SFF (S783), and the second SFF may forward the packet received from the first SFF to the second SF (S785).

Next, a method of performing SFC in a case in which a backup SF, with which an SF in which a failure occurs is replaced, is not present as illustrated in FIG. 8 is provided as follows. That is, the case in which the backup SF, with which the SF in which the failure occurs is replaced, is not present will be described.

A controller may generate a forwarding rule and a backup path based on a customer profile or the like (S810). Here, the forwarding rule may be understood as a concept corresponding to an SFP.

The controller may set the generated forwarding rule and backup path to a first SFF and a second SFF (S821, S822, S831, and S832).

The first SFF may forward the packet to a first SF according to the forwarding rule set by the controller (S840).

The first SFF may detect that a failure occurs in the first SF to which the packet is forwarded (S850).

When it is determined that the backup SF, with which the first SF is replaced, is not present, the first SFF may determine whether a function of the first SF in which the failure occurs is essential or not (S860).

When it is determined that the function of the SF in which the failure occurs is inessential, the first SFF may bypass the SF in which the failure occurs. That is, the first SFF may forward the packet to the second SFF (S863), and the second SFF may forward the packet to a second SF (S865).

Further, the first SFF may determine whether the first SF is or not a last SF for the SFC (S870).

When it is determined that the first SF is the last SF, the first SFF may remove an SFC header according to the end of the SFC (S871).

When it is determined that the first SF is not the last SF, the first SFF may forward the packet to the second SFF which is a next SFF (S873), and the second SFF may forward the packet received from the first SFF to the second SF (S875).

Further, when it is determined that the function of the first SF in which the failure occurs is essential, the first SFF may notify the controller that the failure occurs (S861), and thus the controller may notify the operator that the failure occurs (S880).

Further, the controller having received information on the failure may generate a new forwarding rule (S881), and set the new forwarding rule to the first SFF and the second SFF (S891 and S892).

Referring again to FIG. 3, the system of performing the SFC according to an embodiment of the invention may include the controller and the network device (or SFF).

The controller 100 may determine the SFP based on the topology DB.

The network device may process the received packet according to the SFP determined by the controller 100, and the received packet may be processed according to information on an event generated in an SF in which the received packet is processed and whether the function of the SF is essential or not.

For example, when a failure occurs in the SF, the network device may forward the received packet to a backup SF as it is determined that the backup SF, with which the SF in which the failure occurs is replaced, is set.

Further, when the failure occurs in the SF, the network device may notify the controller of information on the SF in which the failure occurs as it is determined that the backup SF, with which the SF in which the failure occurs is replaced, is not set and the function of the SF in which the failure occurs is essential. Here, the controller may re-calculate a new SFP on which the received packet is processed corresponding to the reception of the information on the SF in which the failure occurs, and set the new re-calculated SFP to the network device.

Further, when the failure occurs in the SF, the network device may bypass the SF in which the failure occurs as it is determined that the backup SF, with which the SF in which the failure occurs is replaced, is not set and the function of the SF in which the failure occurs is inessential.

While each component of the system of performing the SFC according to the embodiment of the invention is listed and described by a respective configuration unit for convenience of description, at least two units among configuration units may be combined into one configuration unit, or one configuration unit may be split into several configuration units to perform functions. Such integrated and separated embodiments of each of the configuration units fall within the scope of the invention without departing from the spirit of the invention.

Further, the operations of the method of performing the SFC according to the embodiment of the invention can be implemented as computer-readable programs or codes in a computer-readable recording medium. The computer-readable recording medium includes all types of recording media in which computer-readable data is stored. Further the computer-readable recording medium may be distributed over computer systems connected to a network and thus the computer-readable programs or codes may be stored and executed in a distributed manner.

The above-described system and method of performing the SFC according to the embodiment of the invention may be divided into the mandatory SF and the optional SF based on the function of the SF or the setting for the SFC and the SFC can be more stably implemented based on the division.

Further, a phenomenon in which the forwarding of the entire traffic is interrupted due to the failure in the SF can be effectively prevented.

In the method and system of performing the SFC according to the example embodiments of the present invention, the SFs can be categorized into mandatory SFs and optional SFs based on the functions of the SFs or the setting for the SFC and the SFC can be more stably implemented based on the categorization.

Further, a phenomenon in which the forwarding of entire traffic is interrupted due to the failure in the SF can be effectively prevented.

While the example embodiments of the inventive concept and their advantages have been described in detail, it should be understood that various changes, substitutions, and alterations may be made herein without departing from the scope of the invention

What is claimed is:

1. A method of performing service function chaining (SFC) by a network device, the method comprising:
determining a service function path (SFP) for a packet transmitted to the network device;
determining a service function (SF) through which the received packet passes on the SFP; and
processing the received packet based on whether a function of the SF is essential or not.

2. The method of claim 1, wherein the SFP is set by a controller which controls the network device for the SFC.

3. The method of claim 1, wherein the processing of the received packet includes, when a failure occurs in the SF, interrupting forwarding of the received packet and notifying a controller which controls the network device of the failure as it is determined that the function of the SF in which the failure occurs is essential.

4. The method of claim 3, wherein the processing of the received packet includes forwarding the received packet according to a path re-calculated by the controller which receives the failure.

5. The method of claim 1, wherein the processing of the received packet includes, when a failure occurs in the SF, bypassing the SF in which the failure occurs as it is determined that the function of the SF in which the failure occurs is inessential.

6. The method of claim 1, wherein the processing of the received packet includes, when a failure occurs in the SF, forwarding the received packet to the set backup SF as it is determined that a backup SF, with which the SF in which the failure occurs is replaced, is set.

7. The method of claim 1, wherein the processing of the received packet includes, when a failure occurs in the SF, determining whether the function of the SF in which the failure occurs is essential or not as it is determined that a backup SF, with which the SF in which the failure occurs is replaced, is not set.

8. The method of claim 1, wherein the processing of the received packet includes determining whether the function of the SF is essential or not according to the SFC applied to the received packet.

9. A method of performing SFC by a controller, the method comprising:
setting an SFP to a network device based on a topology database (DB);
receiving information on an event generated in an SF located on the SFP from the network device; and
controlling the network device according to whether a function of the SF in which the event is generated is essential or not and the received event information.

10. The method of claim 9, wherein the controlling of the network device includes:
receiving information on an event corresponding to a failure which occurs in the SF, and calculating a new SFP as it is determined that the function of the SF in which the failure occurs is essential; and
setting the new SFP to the network device.

11. The method of claim 10, wherein the calculating of the new SFP includes calculating the new SFP by considering whether a backup SF, with which the SF in which the failure occurs is replaced, is set or not.

12. The method of claim 9, wherein the controlling of the network device includes receiving information on an event corresponding to a failure which occurs in the SF and controlling to bypass the SF in which the failure occurs as it is determined that the function of the SF in which the failure occurs is inessential.

13. A system of performing SFC, comprising:
a controller configured to determine an SFP based on a topology DB; and
a network device configured to process a received packet according to the SFP determined by the controller, wherein the received packet is processed according to information on an event generated in an SF in which the received packet is processed and whether a function of the SF is essential or not.

14. The system of claim 13, wherein the network device forwards, when a failure occurs in the SF, the received packet to a backup SF as it is determined that the backup SF, with which the SF in which the failure occurs is replaced, is set.

15. The system of claim 13, wherein the network device notifies, when a failure occurs in the SF, the controller of information on the SF in which the failure occurs as it is determined that a backup SF, with which the SF in which the failure occurs is replaced, is not set and the function of the SF in which the failure occurs is essential.

16. The system of claim 15, wherein the controller re-calculates a new SFP, on which the received packet is processed, corresponding to the reception of the information on the SF in which the failure occurs and sets the new re-calculated SFP to the network device.

17. The system of claim 13, wherein the network device bypasses, when a failure occurs in the SF, the SF in which the failure occurs as it is determined that a backup SF, with which the SF in which the failure occurs is replaced, is not set and the function of the SF in which the failure occurs is inessential.
